(19) United States
(12) Patent Application Publication
(10) Pub. No.: US 2022/0191573 A1
(43) Pub. Date: Jun. 16, 2022

(54) AUTOMATED VIDEO GENERATION

(71) Applicant: Raymond Gladwell, Williston, FL (US)

(72) Inventor: Raymond Gladwell, Williston, FL (US)

(21) Appl. No.: 17/540,365

(22) Filed: Dec. 2, 2021

Related U.S. Application Data
(60) Provisional application No. 63/126,486, filed on Dec. 16, 2020.

(51) Int. Cl. H04N 21/2743; H04N 21/84; G11B 27/34; G11B 27/034; H04N 21/854

(52) U.S. Cl. CPC H04N 21/2743; H04N 21/84; H04N 21/854; G11B 27/034; G11B 27/34

(57) ABSTRACT

Aspects of the invention include combining a first video segment and a second video segment to generate a composite video, where the first video segment and the second video segment comport to a template generated by a third party. The composite video is uploaded to a video hosting service. A uniform resource locator for the uploaded video is retrieved from the video hosting service. The uniform resource locator is transmitted to the third party that generated the template.

### BACKGROUND

The present invention generally relates to programmable computing systems, and more specifically, to programmable computing systems configured for automated video generation for auction houses.

Video editing is a computer-implemented post-production process for manipulating a video in order to output a new video. The degree of technical difficulty for editing the video is commensurate with the degree of the desired manipulation for the original video.

### SUMMARY

Embodiments of the present invention are directed to a computer-implemented method for automated video generation for auction houses, businesses, and individuals. A non-limiting example of the computer-implemented method includes combining a first video segment and a second video segment to generate a composite video, where the first video segment and the second video segment comport to a template generated by a third party. The composite video is uploaded to a video hosting service. A uniform resource locator for the uploaded video is retrieved from the video hosting service. The uniform resource locator is transmitted to the third party that generated the template.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a system for automated video generation in accordance with one or more embodiments of the present invention;

FIG. 2 illustrates a selection page for automated video generation in accordance with one or more embodiments of the present invention;

FIG. 3 illustrates a video creation page for automated video generation in accordance with one or more embodiments of the present invention;

FIG. 4 illustrates a process flow for an automated video generation environment according to one or more embodiments of the present invention;

FIG. 5 illustrates a cloud computing environment according to one or more embodiments of the present invention;

FIG. 6 illustrates abstraction model layers according to one or more embodiments of the present invention; and

FIG. 7 illustrates a block diagram of a computer system for use in implementing one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the present invention provide computer-implemented methods, computing systems, and computer program products that allow auction houses to provide a template to sellers that provide a format for creating a video used for a pre-auction presentation.

Horse auctions are platforms that provide horse sellers an opportunity to relieve themselves of unwanted horses. Prior to the auctions, sellers have an opportunity to present their horse to potential buyers for a pre-auction inspection of each horse. Horse auction houses provide catalogs that include descriptions of the horses for sale to interested buyers. For example, a catalog can include, but not be limited to, one or more of the following, each horses' lot number, whether a horse is gelded, name, sex, foaling date, color, consignor, location, pedigree chart (including sire and dam), written description, and a picture of the horse. The picture of the horse verifies some information from the catalog and provides some information as to the horse's health. The pictures only convey partial information, and due to a horse owner's inexperience with photography, the picture may not convey all of the information that is intended. Furthermore, the picture may not be in line with an auction house's desired format.

One or more embodiments of the present invention address one or more of the above-described shortcomings by providing computer-implemented methods, computing systems, and computer program products that provide horse auction owners the ability to upload reconfigurable image templates to a server that owners can retrieve and generate video presentations that conform to an auction house's standards. The videos are further uploaded to a video-sharing service, and a uniform resource locator (URL) for the video is retrieved from the service and transmitted to the auction house.

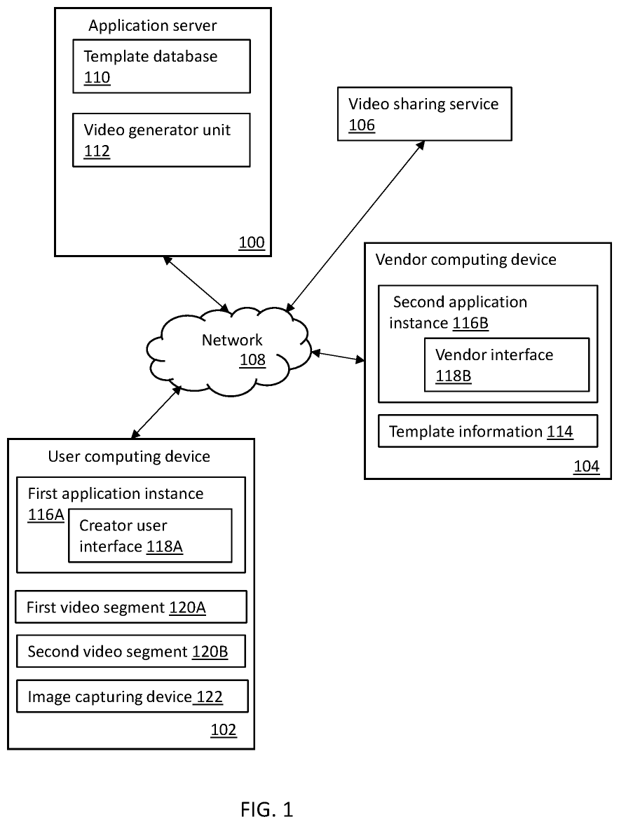

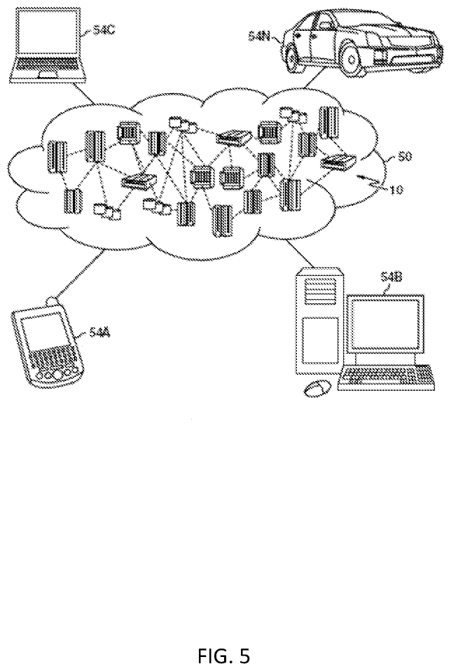

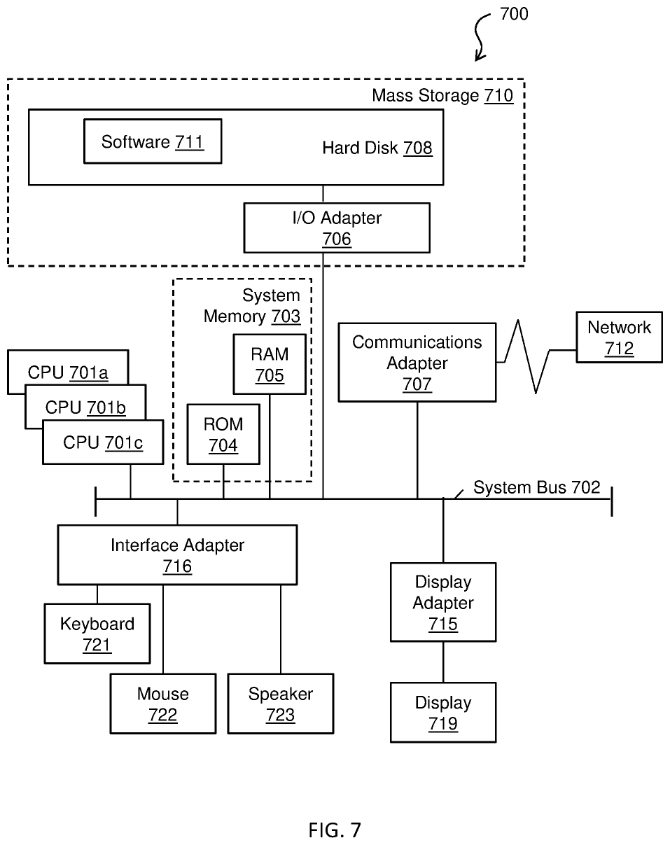

Referring to FIG. 1, an application server 100, a user computing device 102, a vendor computing device 104, and a video-sharing service 106 for generating video content are shown in accordance with one or more embodiments of the present invention. An auction house uses the vendor computing device 104 to provide template information 114 to a template database 110 of the application server 100. The application server 100 includes the template database 110 that includes computer memory for storing one or more templates from one or more auction houses. The application server 100 further includes a video generator unit 112 for receiving video segments from the user computing device 102 and generating a video in conformity with a template stored in the template database 110. The video generator unit 112 further uploads the generated video to the video-sharing service 106 and retrieves a uniform resource locator (URL) for the video. The video generator unit 112 transmits the URL to the auction house, which can then integrate the URL into their catalog. It should be appreciated that some or all of the functionality described herein can be performed in a cloud computing environment, for example, the cloud computing environment 50 shown in FIG. 5; or a computer system, for example, the computer system 700 shown in FIG. 7.

The application server 100, the user computing device 102, the vendor computing device 104, and the video-sharing service 106 are in operable communication via a network 108. The network 108 is operable to enable communication using various technologies, for example, Ethernet, fiber optics, microwave, xDSL (Digital Subscriber Line), Wireless Local Area Network (WLAN) technology, wireless cellular technology, BLUETOOTH technology, and/or any other appropriate technology.

A user can access the first application instance 116A via the user computing device 102 (e.g., personal digital assistant (PDA) or cellular telephone 54A, desktop computer 54B, laptop computer 54C, and/or automobile computer system 54N). The first application instance 116A is software configured to assist the user in creating a video and includes a creator user interface 118A, a graphical user interface (GIU) for interacting with the application server 100.

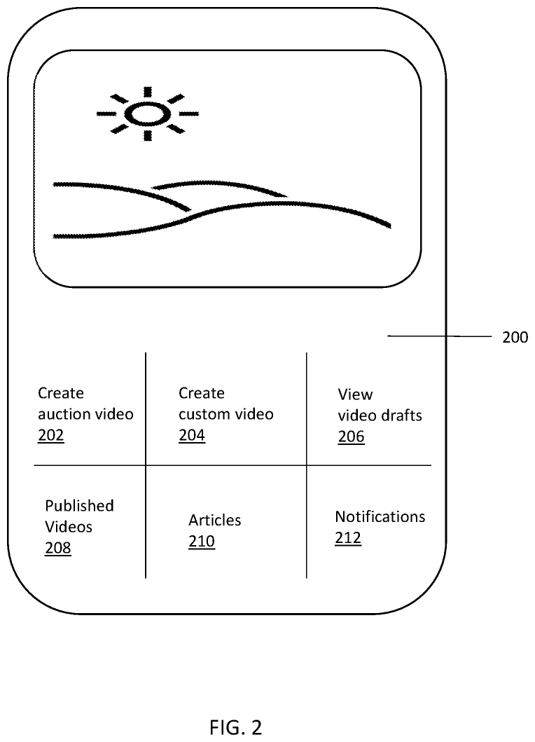

The user can open the first application instance 116A and interact with the application server 100 via the creator user interface 118A. Referring to FIG. 2, a selection page 200 displayed on the creator user interface 118A is shown in accordance with one or more embodiments of the present invention. The selection page 200 includes a set of graphical icons for navigating through the first application instance 116A to create a video. For example, the graphical icons can include, but not be limited to, create auction video icon 202 for creating a video for an auction house catalog, create custom video icon 204 for creating a custom video, view video drafts icon 206 for retrieving and viewing incomplete videos from memory, published videos icon 208 for retrieving and viewing videos from memory, articles icon 210 for retrieving relevant online articles from the interne, and notifications icon 212 for viewing application-related notifications.

The user can select a graphical icon, and the first application instance 116A will direct the user to another page based on the selection. For example, the user can select the for create auction video icon 202, and the first application instance 116A directs the user to an auction page that presents one or more upcoming auctions. The upcoming auctions can be presented in various ways, for example, by a drop-down menu, a table, or other structure. The user selects an auction and is presented with a blank field to provide a password for the auction. The password is provided by either the auction house, application administrator, or some other third party. Upon entering the correct password, the user is directed to an identification page (not shown) that presents a blank hip number field. The hip number is assigned by the auction house and describes the position of the horse in the sales order of the auction. Upon entering the hip number, the first application instance 116A retrieves identifying information of the user's horse from the memory of the application server 100. The identifying information can include, but not be limited to, the sex, name, description of the horse, sire, and dam. The application identifying information is auto-populated on the identification page. The user is provided the opportunity to confirm or edit the identifying information.

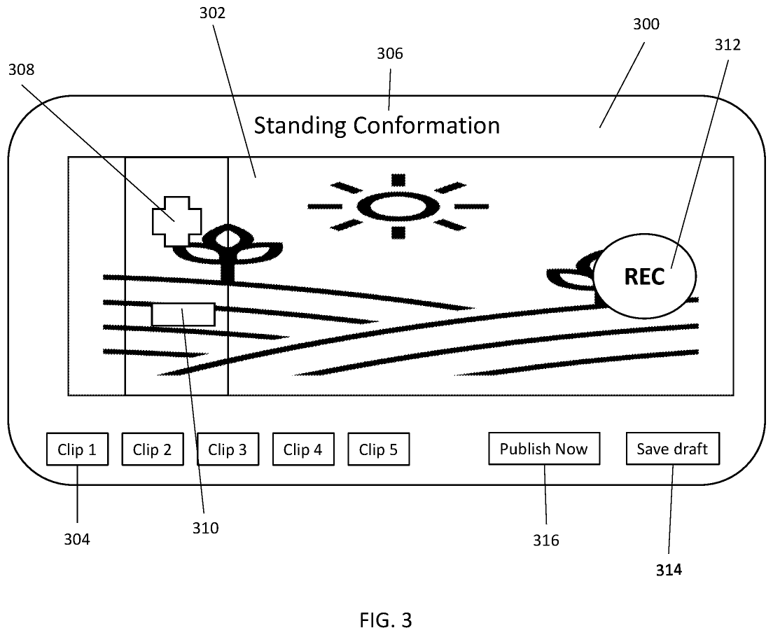

In response to confirming the identifying information, the first application instance 116A directs the user to a video creation page 300 displayed via the creator user interface 118A. Referring to FIG. 3, a video creation page 300 is shown in accordance with one or more embodiments of the present invention. The first application instance 116A further receives instructions transmitted by the application server 100 to initialize an image capturing device 122 (e.g., mobile phone camera) of the user computing device 102. The application server 100 further accesses the template database 110 and determines which features of an object to be sold need to be displayed on a video. The application server 100 transmits the number of features and a description of features to the first application instance 116A. The first application instance 116A then presents an icon for each required feature on the video creation page 300. For example, if the auction house required videos for five horse features, the first application instance 116A would generate five icons to be presented on the video creation page 300.

Each icon corresponds to a video clip for a different required feature. For example, the clip 1 icon 304 is for providing a video segment of a standing conformation of a horse. It should be appreciated that although FIG. 3 illustrates five feature clip icons, embodiments of the present invention can present any number of feature clip icons to conform with an auction house's requirements. Upon selecting a feature clip icon, the first application instance 116A presents a description 306 of the required feature at the top of the video creation page 300. The description 306 lets the user know what image needs to be recorded for the auction house. The first application instance 116A further superimposes a zoom-in icon 308 and a zoom-out icon 310 onto a captured image 302 to enable the user to direct the image capturing device 122 to zoom-in or zoom-out. The first application instance 116A further causes a record icon 312 to be superimposed on the captured image 302 that enables the user to instruct the image capturing device 122 to begin, pause, and end recording. In some embodiments of the present invention, a time limit for one or more video segment 120 is pre-designated by the auction house. The pre-designated time limits are stored in the template database 110 and transmitted to the first application instance 116A. In these instances, the first application instance 116A instructs the image capturing device 122 to cease recording after the pre-designated time has expired.

The first application instance 116A can superimpose a timer on the display to warn the user that pre-designated time is running out. Each video segment 120 generated by the user is stored on the user computing device 102. The user can elect to complete fulfilling each clip icon or save their progress and continue later. If the user elects to continue later, they can save their progress by selecting the save draft icon 314. If the user completes fulfilling the instructions for each feature clip icon, the user can select the publish now icon 316.

In response to the selection of the publish now icon 316, the first application instance 116A transmits one or more video segments 120 (e.g., a first video segment 120A and a second video segment 120B) stored on the user computing device 102 to the video generator unit 112 for processing. The video generator unit 112 is operable to combine the video segments to create a single composite video using various techniques. In some embodiments of the present invention, the video generator unit 112 receives a first video segment 120A as a sequence of images that have a first file size, and a second video segment 120B as a sequence of images having a second file size. The video generator unit 112 combines the first video segment 120A and the second video segment 120B into a single composite video having a third file size. The composite video is a computer file capable of being viewed on an online video hosting service. It should be appreciated that although FIG. 1 only illustrates a first video segment 120A and a second video segment 120B, the user computing device 102 can store any number of video segments, and the video generator unit 112 can combine any number of video segments to generate the composite video.

Upon generating the composite video, the video generator unit 112 performs a post-processing to add visual elements to the video. For example, the video generator unit 112 adds a banner to the bottom of the composite video that includes a Hip number, identifying information for the horse, and identifying information for the auction house. The video generator unit 112 can further include information describing the video segment. For example, on the same banner or a different banner, the video generator unit 112 incorporates the description “Standing profile-right side” to indicate that the portion of the composite video displays the right side of the horse. Once the video segment of the right side of the horse is complete, the video generator unit 112 can add another description to the composite video. For example, for another portion of the composite video, the video can include the description “Standing profile-left side” indicating that the portion of the composite video displays the right side of the horse.

The video generator unit 112 then uploads the post-processed composite video to a video-sharing service 106. The video-sharing service 106 includes an online service that consumers can access via the internet. The video generator unit 112 then retrieves a URL for the composite video and transmits the URL to the vendor computing device 104.

The auction house provides template information 114 to the template database 110 at the application server 100 via the vendor computing device 104. The auction opens a second application instance 116B on the vendor computing device 104. The vendor computing device 104 can be any computing device (e.g., personal digital assistant (PDA) or cellular telephone 54A, desktop computer 54B, laptop computer 54C, and/or automobile computer system 54N). The second application instance 116B displays a vendor interface 118B. In some embodiments of the present invention, the vendor is an auction house for horses. In other embodiments of the present invention, the vendor is a business or individual that would like a composite video created. The vendor interface 118B is a graphical user interface (GUI) that is distinct from the creator user interface 118A. The vendor interface 118B provides the auction house with template information 114 to personalize a list of required features for providing video content of an item to be sold at an auction. For example, the auction house can provide their name, identifying information of their key personnel (e.g., auction coordinator), video segment descriptive titles, video segment time lengths, required information and features (e.g., horse identification number, Hip number, gender, sold as identification, horse name, sire, and name). In addition, the auction house can provide an email address for the video generator unit 112 to transmit the URL of the composite video. The auction house can select one or more features, add a feature, subtract a feature to create a personalized template of their requirements for video content. The auction house transmits its requirements in the form of template information 114 to the application server 100. The application server 100 converts the requirements into cells of a comma separated value table and stores the requirements in the template database 110.

In some embodiments of the present invention, rather than an auction house, a business or individual may wish to create and share video content. The business or individual is presented with a graphical user interface (GUI) that is distinct from the creator user interface 118A and the vendor interface 118B. The business or individual user interface enables the business or the individual to describe desired video segments, identify the business or individual, identify key individuals for coordinating video creation, provide a logo to superimposed on video, and other desired information for a personalized template. In addition, the business or individual can use the interface to provide an email address for the video generator unit 112 to transmit the URL of the composite video.

In an exemplary embodiment, an auction house uploads a marketing content template to the template database 110 for a future auction. An owner wishing to auction an item (e.g., horse, automobile) accesses the template via a first application instance 116A executing on a user computing device 102. The owner accesses the uploaded marketing content template via the first application instance 116A. The marketing content template describes each feature required to be presented on a video for the auction. For example, the marketing content template provides instructions that one required feature is a video of a profile of the item, and another required feature is a video of the item in action. A video generator unit 112 generates a composite video from video segments and superimposes descriptions of the item on the composite video. The video is uploaded to a video-sharing service 106. The video generator unit 112 retrieves a unique URL from the video-sharing service 106, and transmits the URL to the auction via an email address of the owner.

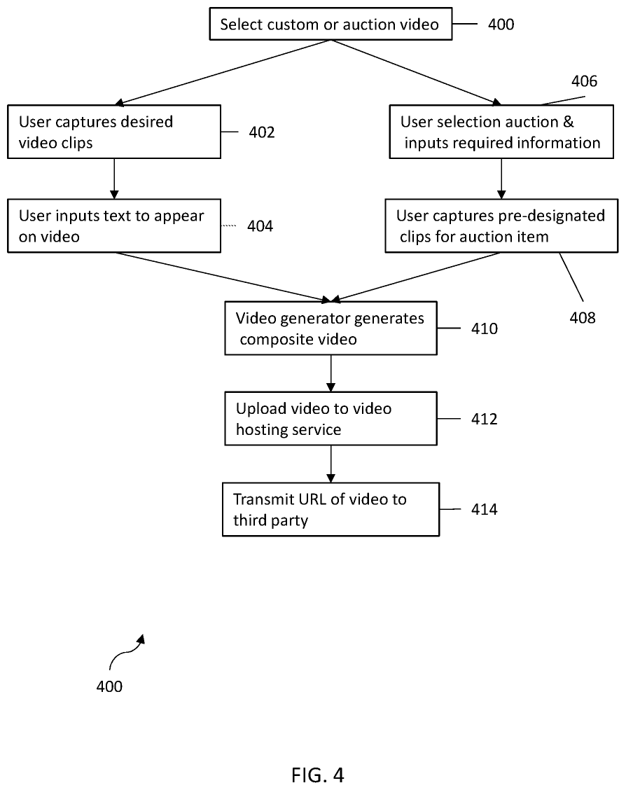

Referring to FIG. 4, a process flow 400 for automated video generation is shown in accordance with one or more embodiments of the present invention. At block 400, a user can choose to select to generate a custom video or an auction video. For example, a user can access a selection page 200 of a creator user interface 118A and select either a create auction video icon 202 or select a create custom video icon 204.

If the user selects the create custom video icon 204, the process flow 400 proceeds to block 402. At block 402, the user captures at least a first video segment 120A and a second video segment 120B. Once the user selects the create custom video icon 204, a first application instance 116A can activate an image capturing device 122 and allow the user to capture the first video segment 120A. The user can then continue and capture a second video segment 120B. At block 404, the user is permitted to add text to the be included in the video. For example, the creator user interface 118A can present the user with blank fields and allow the user to add text or symbols to the fields for inclusion in a composite video.

If the user selects the create auction video icon 202, the process flow 400 moves to block 406. At block 406, the user accesses a first application instance 116A and accesses a creator user interface 118A. The user then selects an auction and enters a password to access a template via the creator user interface 118A for the auction. An application server 100 retrieves information from a template database 110 as to the requirements for a video to be presented for the auction. The template is displayed to the user via the creator user interface 118A. In some embodiments of the present invention, the information is generated from template information 114 is provided by an auction house, and stored in a CSV table. The CSV is stored in the template database 110. The application server 100 then transmits the information to the user computing device 102.

At block 408, the first application instance 116A creates a video creation page 300 that includes a feature icon for each feature required by the auction house as described information in the template database 110. The user engages an image capturing device 122 and creates video segments for each required feature. Once the user has completed generating video segments, the user selects a publish now icon 316, and the video segments are transmitted to the application server 100 for processing.

At block 410, a video generator unit 112 of the application server 100 receives each of the video segments and combines the segments to generate a composite video. The video generator unit 112 further incorporates textual descriptions into the composite video. The textual descriptions include a description of the video segment, a description of an object (e.g., a horse), and an identification of the auction house.

At block 412, the video generator unit 112 uploads the processed composite video to a video-sharing service 106. The video-sharing service 106 can be any online service that allows consumers to access uploaded videos. In addition to uploading the composite video, the video generator unit 112 retrieves a URL of the video from the video-sharing service 106. At block 414, the video generator unit 112 transmits the URL to a third party, for example, the auction house.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

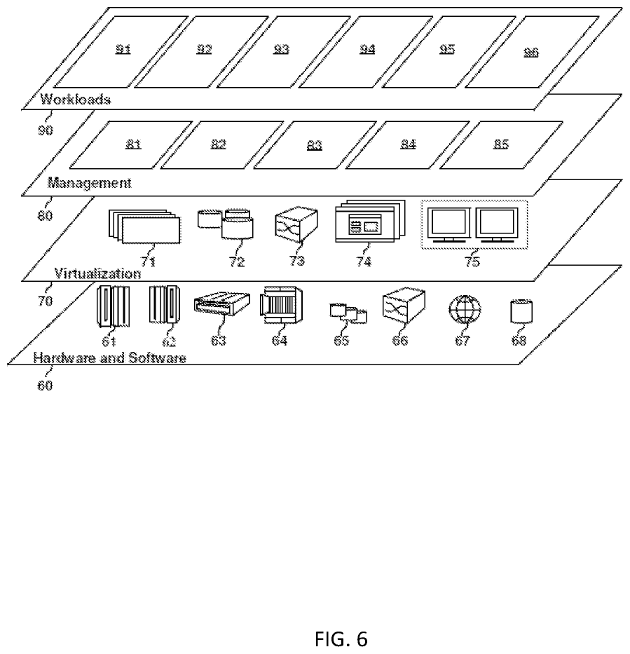

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtualization 93; data analytics processing 94; transaction processing 95; and automated video generation 96.

In one or more embodiments of the present invention, the hardware/software modules from FIG. 1 can be implemented on the processing system 500 found in FIG. 5. Turning now to FIG. 5, a computer system 500 is generally shown in accordance with an embodiment. The computer system 500 can be an electronic, computer framework comprising and/or employing any number and combination of computing devices and networks utilizing various communication technologies, as described herein. The computer system 500 can be easily scalable, extensible, and modular, with the ability to change to different services or reconfigure some features independently of others. The computer system 500 may be, for example, a server, desktop computer, laptop computer, tablet computer, or smartphone. In some examples, computer system 500 may be a cloud computing node, such as a node 10 of FIG. 5. Computer system 500 may be described in the general context of computer system executable instructions, such as program modules, being executed by a computer system. Generally, program modules may include routines, programs, objects, components, logic, data structures, and so on that perform particular tasks or implement particular abstract data types. Computer system 500 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, the computer system 700 has one or more central processing units (CPU(s)) 701a, 701b, 701c, etc. (collectively or generically referred to as processor(s) 701). The processors 701 can be a single-core processor, multi-core processor, computing cluster, or any number of other configurations. The processors 701, also referred to as processing circuits, are coupled via a system bus 702 to a system memory 703 and various other components. The system memory 703 can include a read only memory (ROM) 704 and a random access memory (RAM) 705. The ROM 704 is coupled to the system bus 702 and may include a basic input/output system (BIOS), which controls certain basic functions of the computer system 700. The RAM is read-write memory coupled to the system bus 702 for use by the processors 701. The system memory 703 provides temporary memory space for operations of said instructions during operation. The system memory 703 can include random access memory (RAM), read only memory, flash memory, or any other suitable memory systems.

The computer system 700 comprises an input/output (I/O) adapter 706 and a communications adapter 707 coupled to the system bus 702. The I/O adapter 706 may be a small computer system interface (SCSI) adapter that communicates with a hard disk 708 and/or any other similar component. The I/O adapter 706 and the hard disk 708 are collectively referred to herein as a mass storage 710.

Software 711 for execution on the computer system 700 may be stored in the mass storage 710. The mass storage 710 is an example of a tangible storage medium readable by the processors 701, where the software 711 is stored as instructions for execution by the processors 701 to cause the computer system 700 to operate, such as is described herein below with respect to the various Figures. Examples of computer program product and the execution of such instruction is discussed herein in more detail. The communications adapter 707 interconnects the system bus 702 with a network 712, which may be an outside network, enabling the computer system 700 to communicate with other such systems. In one embodiment, a portion of the system memory 703 and the mass storage 710 collectively store an operating system, which may be any appropriate operating system to coordinate the functions of the various components shown in FIG. 7.

Additional input/output devices are shown as connected to the system bus 702 via a display adapter 715 and an interface adapter 716 and. In one embodiment, the adapters 706, 707, 715, and 716 may be connected to one or more I/O buses that are connected to the system bus 702 via an intermediate bus bridge (not shown). A display 719 (e.g., a screen or a display monitor) is connected to the system bus 702 by a display adapter 715, which may include a graphics controller to improve the performance of graphics intensive applications and a video controller. A keyboard 721, a mouse 722, a speaker 723, etc. can be interconnected to the system bus 702 via the interface adapter 716, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 7, the computer system 700 includes processing capability in the form of the processors 701, and, storage capability including the system memory 703 and the mass storage 710, input means such as the keyboard 721 and the mouse 722, and output capability including the speaker 723 and the display 719.

In some embodiments, the communications adapter 707 can transmit data using any suitable interface or protocol, such as the internet small computer system interface, among others. The network 712 may be a cellular network, a radio network, a wide area network (WAN), a local area network (LAN), or the Internet, among others. An external computing device may connect to the computer system 700 through the network 712. In some examples, an external computing device may be an external webserver or a cloud computing node.

It is to be understood that the block diagram of FIG. 7 is not intended to indicate that the computer system 700 is to include all of the components shown in FIG. 7. Rather, the computer system 500 can include any appropriate fewer or additional components not illustrated in FIG. 7 (e.g., additional memory components, embedded controllers, modules, additional network interfaces, etc.). Further, the embodiments described herein with respect to computer system 700 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
combining, by a processor, a first video segment and a second video segment to generate a composite video, wherein the first video segment and the second video segment comport to a template generated by a third party;
uploading, by the processor, the composite video to a video hosting service;
retrieving, by the processor, a uniform resource locator for the uploaded video; and
transmitting, by the processor, the uniform resource locator to the third party.

2. The computer-implemented method of claim 1, wherein the method further comprises:
receiving, via the template, an electronic mail address of the third party; and
transmitting the uniform resource locator to the electronic mail address third party.

3. The computer-implemented method of claim 1, wherein the method further comprises:
receiving a selection of an event from a user computing device, wherein the event is associated with a template stored in a database;
retrieving the template from the database; and
transmitting the template to the user computing device.

4. The computer-implemented method of claim 1, wherein the method further comprises:
receiving a selection from a mobile computing device to create a video;
transmitting an instruction to the mobile computing device to initialize an image capturing device based on the selection to create the video.

5. The computer-implemented method of claim 1, wherein the method further comprises:
receiving via the template a textual description of the first video segment; and
processing the composite video to display the textual description at the first video segment portion of the composite video.

6. The computer-implemented method of claim 1, wherein the method further comprises:
receiving a textual description of an object displayed on the first video segment; and
processing the composite video to display the textual description of the object at the first video segment portion of the composite video.

7. The computer-implemented method of claim 6, wherein the textual description of the object is retrieved based on receiving an identification number associated with an auction.

8. A system comprising:
a memory having computer readable instructions; and
one or more processors for executing the computer readable instructions, the computer readable instructions controlling the one or more processors to perform operations comprising:
combining a first video segment and a second video segment to generate a composite video, wherein the first video segment and the second video segment comport to a template generated by a third party;
uploading the composite video to a video hosting service;
retrieving a uniform resource locator for the uploaded video; and
transmitting the uniform resource locator to the third party.

9. The system of claim 8, wherein the operations further comprise:
receiving, via the template, an electronic mail address of the third party; and
transmitting the uniform resource locator to the electronic mail address third party.

10. The system of claim 8, wherein the operations further comprise:
receiving a selection of an event from a user computing device, wherein the event is associated with a template stored in a database;
retrieving the template from the database; and
transmitting the template to the user computing device.

11. The system of claim 8, wherein the operations further comprise:
receiving a selection from a mobile computing device to create a video;
transmitting an instruction to the mobile computing device to initialize an image capturing device based on the selection to create the video.

12. The system of claim 8, wherein the operations further comprise:
receiving via the template a textual description of the first video segment; and
processing the composite video to display the textual description at the first video segment portion of the composite video.

13. The system of claim 8, wherein the operations further comprise:
receiving a textual description of an object displayed on the first video segment; and
processing the composite video to display the textual description of the object at the first video segment portion of the composite video.

14. The system of claim 13, wherein the textual description of the object is retrieved based on receiving an identification number associated with an auction.

15. A computer program product comprising a computer readable storage medium having program instructions embodied therewith, the program instructions executable by a processor to cause the processor to perform operations comprising:
combining a first video segment and a second video segment to generate a composite video, wherein the first video segment and the second video segment comport to a template generated by a third party;
uploading the composite video to a video hosting service;
retrieving a uniform resource locator for the uploaded video; and
transmitting the uniform resource locator to the third party.

16. The computer program product of claim 15, wherein the operations further comprise:
receiving, via the template, an electronic mail address of the third party; and
transmitting the uniform resource locator to the electronic mail address third party.

17. The computer program product of claim 15, wherein the operations further comprise:
receiving a selection of an event from a user computing device, wherein the event is associated with a template stored in a database;
retrieving the template from the database; and
transmitting the template to the user computing device.

18. The computer program product of claim 15, wherein the operations further comprise:
receiving a selection from a mobile computing device to create a video;
transmitting an instruction to the mobile computing device to initialize an image capturing device based on the selection to create the video.

19. The computer program product of claim 15, wherein the operations further comprise:
receiving via the template a textual description of the first video segment; and
processing the composite video to display the textual description at the first video segment portion of the composite video.

20. The computer program product of claim 15, wherein the operations further comprise:
receiving a textual description of an object displayed on the first video segment; and
processing the composite video to display the textual description of the object at the first video segment portion of the composite video.
